(19) United States
(12) Patent Application Publication
(10) Pub. No.: US 2009/0221205 A1
(43) Pub. Date: Sep. 3, 2009

(54) Doctor Blade for the Roll of a Paper or Board Machine and Method for Manufacturing the Doctor Blade

(75) Inventors: Harri Matilainen, Mikkeli (FI); Hans Hede, Voyri (FI)

Correspondence Address: BIRCH STEWART KOLASCH & BIRCH, PO BOX 747, FALLS CHURCH, VA, 22040-0747, US

(73) Assignee: EXEL OYJ, Mäntyharju (FI)

(21) Appl. No.: 12/086,231

(22) PCT Filed: Dec. 5, 2006
(86) PCT No.: PCT/FI2006/050539

§ 371 Date: May 4, 2009

(30) Foreign Application Priority Data
Dec. 7, 2005 (FI) 20055651

(51) Int. Cl. B32B 5/26; B32B 5/30; B29C 65/00; B29C 65/70

(52) U.S. Cl. 442/389; 442/393; 442/391; 156/307.3; 156/244.23

(57) ABSTRACT

The invention relates to a doctor blade for the roll of a paper or board machine and a method for manufacturing the doctor blade. At least one fiber fabric (6a), having its fibers coated with hard particles prior to lamination, is supplied to the vicinity of that surface (4) of the blade which terminates in a cutting edge (2). The particle size is less than 30 μm. There are typically several fiberglass sheets coated with hard particles and the disposition thereof is such that in the vicinity of blade surfaces, at least in the vicinity of the surface (4) terminating in the cutting edge, the wear resistance is better than in the mid-section of a blade edge (3).

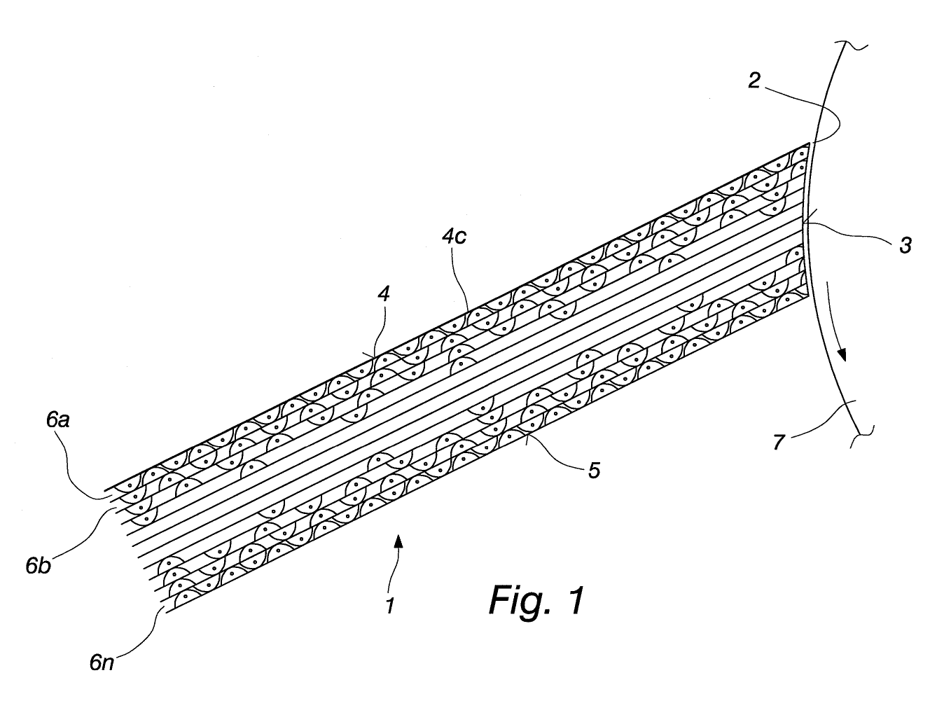

The invention relates to a doctor blade for the roll of a paper or board machine, comprising two opposite surfaces, one of which terminates in a cutting edge, the blade consisting of fiber sheets laminated on top of each other and bonded together with a plastic matrix.

The invention relates also to a method for manufacturing a doctor blade, said method comprising
laminating a number of fiber sheets on top of each other,
wetting the fiber sheets in a matrix plastic prior to the lamination, and
setting the matrix plastic by heating.

The lamination can be preferably performed by a pultrusion method, but other prior known lamination methods can be used as well.

This type of doctor blade and its manufacturing method are known from patent publication FI-101637. This prior known blade is provided with a high carbon fiber content, the carbon fibers extending laterally of the blade for conducting heat away from the point of a blade. The particle size is 30-150 μm for creating a roll-surface grinding (conditioning) effect.

An object of the invention is to provide a doctor blade and its manufacturing method, avoiding the use of expensive carbon fiber and resulting in a controlled blade wearing (long service life) and good scraping properties, i.e. a continued sharpness of the cutting edge.

This object is achieved by a doctor blade of the invention on the basis of the characterizing features set forth in the appended claim 1. The object is also achieved by a method of the invention on the basis of the characterizing features set forth in the appended claim 5. The dependent claims present preferred embodiments for the invention.

The invention will now be described in more detail with reference to the accompanying drawing, which shows in a cross-section and in an enlarged scale the point area of a doctor blade according to the invention, in a working position pressed against the surface of a roll 7.

The doctor blade 1 comprises two opposite surfaces 4, 5, of which the surface 4 terminates in a cutting edge 2. The cutting edge 2 performs the actual scraping function, such as removing a web or debris from the roll's 7 surface. The blade 1 of the invention functions principally as a transfer and cleaning doctor for passing a web from one roll to another and for cleaning the roll's 7 surface.

The blade 1 consists of fiber fabrics laminated on top of each other, e.g. glassfiber fabrics 6a-6n, bonded together with a plastic matrix. The glassfiber fabrics 6a-6n are laminated on top of each other e.g. by means of pultrusion technique, wherein the fabrics are wetted in matrix plastics prior to pultrusion and the matrix plastics is set in a heated pultrusion die. The invention makes use of a fiber fabric, because the fabric is left with holes for the matrix plastics to penetrate through and to thereby attain a best possible laminating performance.

At least one fiber fabric, such as a fiberglass fabric 6a-6n, has its fibers coated with hard particles of a size less than 30 μm. Such a fiber fabric 6a, coated with hard particles, lies at or in the immediate vicinity of the surface 4 terminating in the cutting edge 2. The fabric sheet is hollow with holes despite the fact that its fibers are coated with hard particles which are in engagement with the fabrics.

In a preferred embodiment of the invention, the blade comprises several sheets of fiberglass fabric on top of each other. In this case, just those fiberglass sheets, which are present near the blade's surfaces 4, 5, are provided with hard particles or include a larger amount of hard particles or include particles harder than those present in the blade's middle sheets. This is a way of ensuring that at least the cutting edge 2 remains sharp as the mid-section of a blade edge 3 wears down more easily. The continued sharpness of the cutting edge 2 can be further assisted by providing a thin felt mat 4c of carbon fiber at or in the immediate vicinity of the surface 4 terminating in the cutting edge 2. Carbon fiber is not needed anywhere else in the blade structure 1.

What has been realized in the invention is that, by maintaining a particle size of less than 30 μm, the grinding effect caused by a blade can be reduced, resulting in a reduction of abrasion friction and heat evolution with less material released from the plastic matrix onto the blade's 7 surface. At the same time, it is ensured that the blade is wearing down in a controlled manner, which refers to such an extent and distribution of wear within the range of the blade edge 3 which results in a long service life and continued sharpness of the cutting edge 2. Thus, the use of carbon fiber can be avoided as long as the fiberglass fabric is coated with sufficiently small hard particles. The hard particles may consist of any material harder than glass, especially silicon carbide, alumina, zirconium or the like hard ceramic materials useful as hard coating layers. Bonding of the particles to the fibers of a fiber sheet may proceed e.g. as described in patent FI-101637, by impregnating with the assistance of a matrix material in the fiber sheet prior to a pultrusion process or by using conventional methods known from the manufacture of sandwich structures.

The resulting blade has typically a thickness of 1,5-2,5 mm and comprises 6-10 fiber sheets on top of each other. The fact that the fiber sheets are made of fabric facilitates manufacture and stabilizes the blade's rigidity in various orientations. The carbon fiber felt 4c terminating in the cutting edge 2 is as thin as possibly allowed by engineering aspects. Its thickness is typically less than 0,02 mm.

The doctor blade of the invention is preferably manufactured by a pultrusion method, such that the fibers of at least one fiberglass fabric have been coated, prior to pultrusion, with hard particles of a size less than 30 μm. Such a sheet is supplied onto the surface 4 of a resulting blade laminate or into the immediate vicinity of the surface 4. The surface 5 or its immediate vicinity can also be supplied with a second fiberglass fabric, having its fibers coated with hard particles. The fiber fabrics intended for the middle portion of the blade's 1 cross-section do not necessarily require hard particles, or the quantity or hardness thereof must be lesser than those present in the surface sheets. Arranged like this, the fiber sheets are laminated on top of each other by pultrusion technique, wherein the fiber sheets are wetted in matrix plastics which is set in a heated pultrusion die.

The invention brings forth a number of advantages. The use of expensive carbon fiber is avoided, yet the blade has a long service life which in turn reduces the amount of materials released from the blade onto the roll surface.

1. A doctor blade for the roll of a paper or board machine, comprising two opposite surfaces (4, 5), one (4) of which terminates in a cutting edge (2), the blade (1) consisting of fiber sheets (6a-6n) laminated on top of each other and bonded together with a plastic matrix, characterized in that the blade comprises at least one fiber fabric (6a), having its fibers coated with hard particles of a size less then 30 μm, and that the fiber fabric coated with hard particles lies at or in the immediate vicinity of the surface (4) terminating in the cutting edge (2).

2. A doctor blade as set forth in claim 1, characterized in that the fiber fabric (6a) coated with hard particles is a fiberglass fabric.

3. A doctor blade as set forth in claim 1, characterized in that at or in the immediate vicinity of the surface terminating in the cutting edge (2) there is a thin felt mat of carbon fiber.

4. A doctor blade as set forth in claim 1, characterized in that the blade carries a plurality of sheets (6a-6n) of glassfiber fabric on top of each other, and that just those glassfiber sheets which are near the blade surface (4, 5) are provided with hard particles or include a larger amount of hard particles or include particles which are harder than those present in the blade's middle sheets.

5. A method for manufacturing a doctor blade, said method comprising
laminating a number of fiber sheets on top of each other,
wetting the fiber sheets in a matrix plastic prior to the lamination. and
setting the matrix plastic by heating, characterized in that at least one fiber sheet is a fabric, having its fibers coated, prior to lamination, with hard particles of a size less than 30 μm, and such a sheet is laminated on the surface of a resulting blade laminate or in the immediate vicinity of the surface.

6. A method as set forth in claim 5, characterized in that the lamination is performed by a pultrusion method.

7. A method as set forth in claim 5, characterized in that the surface of a resulting blade laminate or the immediate vicinity of the surface is supplied with a thin felt mat of carbon fiber.

8. A method as set forth in claim 5, characterized in that the resulting blade laminate is supplied with a plurality of glassfiber fabrics (6a-6n) on top of each other, and that the fibers of one or more glassfiber fabrics are coated with hard particles.

9. A method as set forth in claim 5, characterized in that the fiber fabrics coated with hard particles are supplied to the vicinity of the blade's surfaces (4, 5) and the blade's mid-section is supplied with one or more fiber fabrics not provided with hard particles.

10. A method as set forth in claim 5, characterized in that the vicinity of the blade's surfaces (4, 5) is supplied with fiber fabrics, which have a larger amount of harder particles or which have particles harder than those present in fiber fabrics supplied into the blade's middle sheets.

11. A doctor blade as set forth in claim 2, characterized in that at or in the immediate vicinity of the surface terminating in the cutting edge (2) there is a thin felt mat of carbon fiber.

12. A doctor blade as set forth in claim 2, characterized in that the blade carries a plurality of sheets (6a-6n) of glassfiber fabric on top of each other, and that just those glassfiber sheets which are near the blade surface (4, 5) are provided with hard particles or include a larger amount of hard particles or include particles which are harder than those present in the blade's middle sheets.

13. A doctor blade as set forth in claim 3, characterized in that the blade carries a plurality of sheets (6a-6n) of glassfiber fabric on top of each other, and that just those glassfiber sheets which are near the blade surface (4, 5) are provided with hard particles or include a larger amount of hard particles or include particles which are harder than those present in the blade's middle sheets.

14. A method as set forth in claim 6, characterized in that the surface of a resulting blade laminate or the immediate vicinity of the surface is supplied with a thin felt mat of carbon fiber.

15. A method as set forth in claim 6, characterized in that the resulting blade laminate is supplied with a plurality of glassfiber fabrics (6a-6n) on top of each other, and that the fibers of one or more glassfiber fabrics are coated with hard particles.

16. A method as set forth in claim 7, characterized in that the resulting blade laminate is supplied with a plurality of glassfiber fabrics (6a-6n) on top of each other, and that the fibers of one or more glassfiber fabrics are coated with hard particles.

17. A method as set forth in claim 6. characterized in that the fiber fabrics coated with hard particles are supplied to the vicinity of the blade's surfaces (4, 5) and the blade's mid-section is supplied with one or more fiber fabrics not provided with hard particles.

18. A method as set forth in claim 7, characterized in that the fiber fabrics coated with hard particles are supplied to the vicinity of the blade's surfaces (4, 5) and the blade's mid-section is supplied with one or more fiber fabrics not provided with hard particles.

19. A method as set forth in claim 8, characterized in that the fiber fabrics coated with hard particles are supplied to the vicinity of the blade's surfaces (4, 5) and the blade's mid-section is supplied with one or more fiber fabrics not provided with hard particles.

20. A method as set forth in claim 6, characterized in that the vicinity of the blade's surfaces (4, 5) is supplied with fiber fabrics, which have a larger amount of harder particles or which have particles harder than those present in fiber fabrics supplied into the blade's middle sheets.
